(19) United States
(12) Patent Application Publication
(10) Pub. No.: US 2012/0223968 A1
(43) Pub. Date: Sep. 6, 2012

(54) DISPLAY PROCESSING DEVICE, DISPLAY METHOD, AND PROGRAM

(76) Inventor: Kazutoshi Kashimoto, Osaka (JP)

(21) Appl. No.: 13/508,577

(22) PCT Filed: Aug. 2, 2011
(86) PCT No.: PCT/JP2011/004368

§ 371 Date: May 8, 2012

(30) Foreign Application Priority Data
Oct. 12, 2010 (JP) 2010229669

(51) Int. Cl. G09G 5/00

(52) U.S. Cl. 345/633

(57) ABSTRACT

A display processing device extracts a marker image from an image (captured image) of a page in a book. Afterward, a curved plane is created according to the extracted marker image to represent the degree of curvature of the page. Then, a virtual object is distorted to match the curved plane and overlaid on the captured image for display on an HMD.

### TECHNICAL FIELD

The present invention pertains to the field of augmented reality.

### BACKGROUND ART

Augmented reality (hereinafter also AR) technology shows a user a virtual object as overlaid on an image of the real world.

In order to realize augmented reality that is perceived with minimal discomfort for the user, an appropriate type of virtual object must be displayed at an appropriate position, in consideration of the real world image.

Relatedly, in Non-Patent Literature 1, a head mounted display (hereinafter, HMD) incorporating a camera is used as a display device, and employs the position and unique pattern of marker captured by the camera to handle the virtual objects to be displayed by the HMD.

### CITATION LIST

### Patent Literature

### [Patent Literature 1]

Japanese Patent No. 3993423

### Non-Patent Literature

### [Non-Patent Literature 1]

Kato et al. “An Augmented Reality System and its Calibration based on Marker Tracking”, Journal of the Virtual Reality Society of Japan, Vol. 4, No. 4, pp. 607-616, 1999

### SUMMARY OF INVENTION

### Technical Problem

The inventor considers a situation where a virtual object is displayed according to a page of a book being read by a user wearing an HMD. The user experience can be made more dynamic by, for example, displaying a character as a virtual object over the background printed on a page of children's book.

Yet, the page to which the book is open is frequently curved while the user is reading. Thus, the virtual object should be displayed in consideration of this real world curve, so as to minimize user discomfort.

In consideration of this problem, the present invention is intended to display a virtual object overlaid on a captured image of a page in a book (an image of the real world), adjusted as appropriate for the degree of curvature of the page.

### Solution to Problem

A display processing device pertaining to the present invention is provided for displaying a virtual object upon overlay on a captured image of a real world environment, and comprises: an acquisition unit acquiring a captured image of a page in a book; an extraction unit extracting one or more marker images from the captured image so acquired; a creation unit creating a curved plane according to the marker images, the curved plane representing a degree of curvature for the page; and a display processing unit modifying a virtual object according to the curved plane and overlaying the virtual object so modified on the captured image for display.

### Advantageous Effects of Invention

The display processing device pertaining to the present invention enables a virtual object to be displayed in a form appropriate to the degree of curvature of the page.

### BRIEF DESCRIPTION OF DRAWINGS

FIG. 1 illustrates an overall aspect of a reading system 1.

FIG. 2 illustrates the appearance of a book 10, when open.

FIG. 3 illustrates an example of internal marker information embedded in markers 2L and 2R.

FIG. 4 is a functional block diagram of an HMD 20.

FIG. 5 is a flowchart of overlay display processing.

FIG. 6 is a flowchart of curved plane calculation processing.

FIG. 7 illustrates three coordinate systems.

FIG. 8 illustrates an example of the curved plane calculation processing.

FIG. 9 further illustrates the example of the curved plane calculation processing.

FIG. 10 illustrates an example of overlay display.

FIG. 11 illustrates an example of internal marker information embedded in markers 2L and 2R.

FIG. 12 is a functional block diagram of an HMD 21.

FIG. 13 illustrates another example of overlay display.

FIG. 14 is a flowchart of the overlay display processing operations.

FIG. 15 is a flowchart of the curved plane calculation processing.

FIG. 16 illustrates an example of neighbouring point setting.

FIG. 17 is a functional block diagram of the HMD 20.

FIG. 18 is a flowchart of the overlay display processing operations.

### DESCRIPTION OF EMBODIMENTS

Embodiments of the present invention are described below, with reference to the accompanying drawings.

### Embodiment 1

Configuration

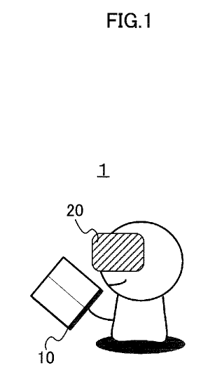

FIG. 1 illustrates a reading system.

As shown, the reading system 1 includes a book 10 and an HMD 20 worn by a user.

The HMD 20 generates an image of two pages (images of the real world) to which the book 10 is open, and enhances or complements the content of the book 10 by overlaying a virtual object thereon, according to the current page.

In order to avoid user discomfort when viewing the overlay display, the virtual object is preferably displayed as if it truly existed on the paper page.

However, the paper pages of the book 10 are prone to curving. Thus, when the virtual object is displayed as if pasted along a flat plane, the user may feel discomfort if the virtual object appears to be shifted either length-wise or depth-wise with respect to the page.

As such, the reading system 1 of the present invention creates a curved plane corresponding to the curvature of the actual page, then proceeds to overlay the virtual object in a shape appropriate to the created curved plane.

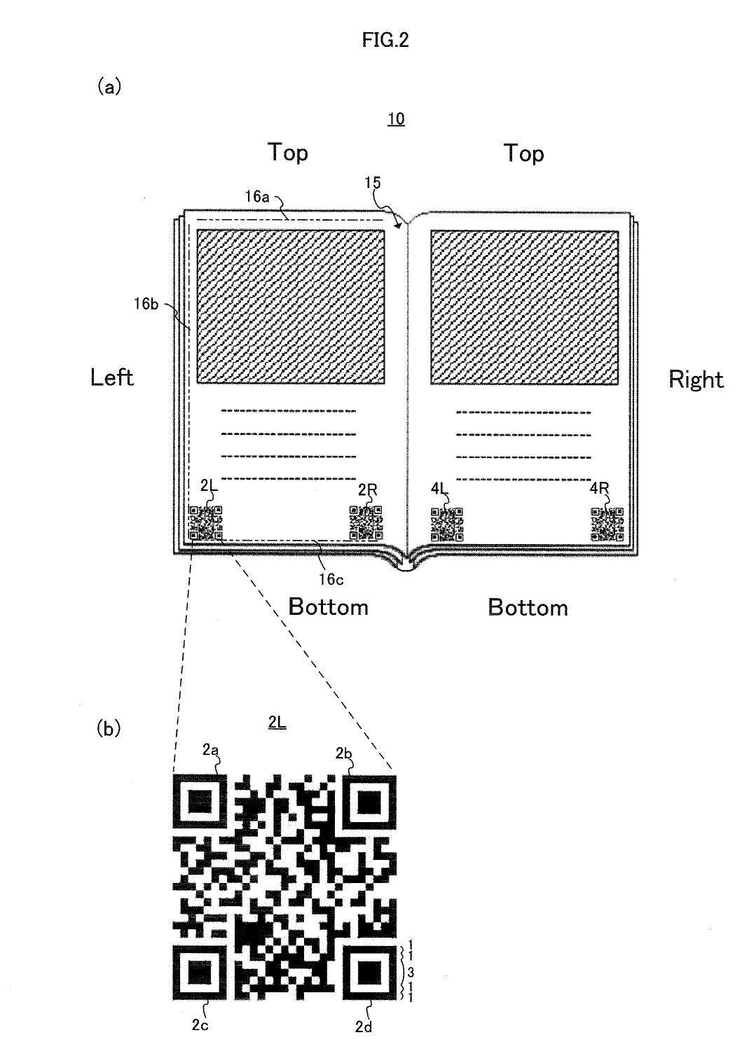

FIG. 2 illustrates the appearance of the book 10, when open.

FIG. 2 shows a left page of the book 10, along with markers 2L and 2R respectively printed in the lower-left and lower-right corners of the page. Similarly, markers 4L and 4R are printed on the right page. The configuration of the left and right pages are thus similar. As such, the following explanations center on the portions used for overlay display on the left page.

Within the book 10, the portions of the pages in contact with the spine are termed a gutter 15, and the other three sides are termed edges 16a through 16c (indicated by double-dashed chain lines in FIG. 2). Specifically, edge 16a is called the top edge while the edge 16c is called the bottom edge.

Marker 2L is described below with reference to FIG. 2B. The other markers, namely 2R, 4L, and 4R, are configured similarly to marker 2L.

Marker 2L includes locator symbols 2a through 2d arranged at the four corners thereof, with the remaining space being filled by a black and white pattern. Each locator symbol 2a through 2d has black (b) and white (w) portions in a length ratio such that b:w:b:w:b=1:1:3:1:1. This ratio is used to detect the size and position of marker 2L.

Marker 2L thus resembles a quick Response (hereinafter, QR) code, which is a type of two-dimensional code. However, QR codes have locator symbols in only three corners, whereas marker 2L has locator symbols in all four corners and thus differs from a QR code.

Further, like a QR code, the black and white pattern of marker 2L can be used to encode up to a few kilobytes of information. The information encoded in markers 2L and 2R is hereinafter termed internal marker information.

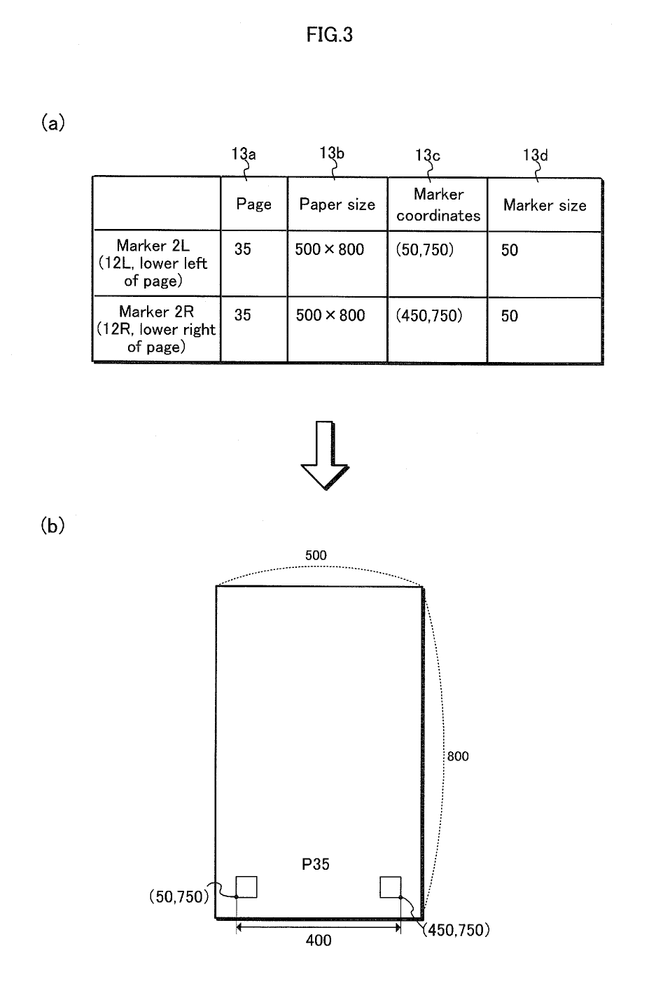

FIG. 3 illustrates an example of internal marker information.

As shown in FIG. 3, the internal marker information includes four items, respectively indicating a page 13a on which the marker is printed within the book, a paper size 13b for the page, marker coordinates 13c, and a marker size 13d. The marker coordinates 13c indicate whichever of the four vertices of the marker is both furthest from the center of the page and lowest along the length of the page.

FIG. 3B is a diagram of the information obtainable from the internal marker information given in FIG. 3. Specifically, the coordinates two markers 2L and 2R, namely (50, 750) and (450, 750), serve to establish an inter-marker distance of 400.

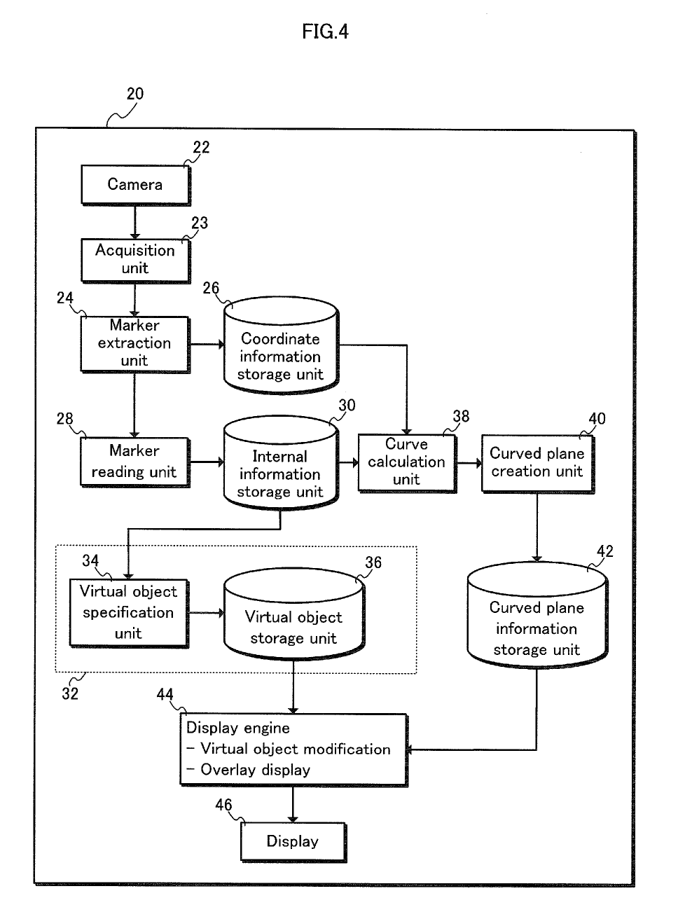

FIG. 4 is a functional block diagram of the HMD 20.

The HMD 20 includes a camera 22, an acquisition unit 23, a marker extraction unit 24, a coordinate information storage unit 26, a marker reading unit 28, an internal information storage unit 30, a virtual object acquisition unit 32, a curve calculation unit 38, a curved plane creation unit 40, a curved plane information storage unit 42, a display engine 44, and a display 46.

The camera 22 generates an image by capturing a subject. For example, a multi-megapixel CMOS (Complementary Metal Oxide Semiconductor) camera may be attached to the HMD 20 casing, and oriented to match the line of sight of the user wearing the HMD 20.

The acquisition unit 23 acquires the image captured by the camera 22.

The marker extraction unit 24 extracts a marker image area by detecting locator symbols 2a through 2d in the image acquired by the acquisition unit 23.

In the present description, a distinction is made between markers actually printed on a page, simply called markers, and markers extracted from a captured image, called marker images.

Coordinate information indicating the coordinates of the marker image area so extracted are then stored in the coordinate information storage unit 26.

The marker reading unit 28 reads the internal marker information from the marker image area extracted by the marker extraction unit 24, then stores the information so read in the internal information storage unit 30. This reading may be performed using methods employed with QR codes.

The virtual object acquisition unit 32 includes a virtual object specification unit 34 and a virtual object storage unit 36.

The virtual object storage unit 36 stores a plurality of virtual objects in association with page numbers.

The virtual object specification unit 34 specifies a virtual object associated with a page number among the plurality of virtual objects stored in the virtual object storage unit 36 according to a page number in the internal information stored in the internal information storage unit 30.

For example, when, as shown in FIG. 3, the page information reads 35, the virtual object specification unit 34 specifies any virtual objects associated with page 35 among the virtual objects stored in the virtual object storage unit 36.

The curve calculation unit 38 calculates a curve indicating the curvature of the page to which the book 10 is open, as captured by the camera 22. The calculation is made according to the coordinate information stored in the coordinate information storage unit 26 and the internal information stored in the internal information storage unit 30.

The curved plane creation unit 40 calculates a curved plane according to the curve calculated by the curve calculation unit 38, for storage in the curved plane information storage unit 42.

The display engine 44 modifies (reworks) the virtual object specified by the virtual object specification unit 34 for the curved plane stored in the curved plane information storage unit 42 and displays the modified virtual object as an overlay on the display 46.

(Operations)

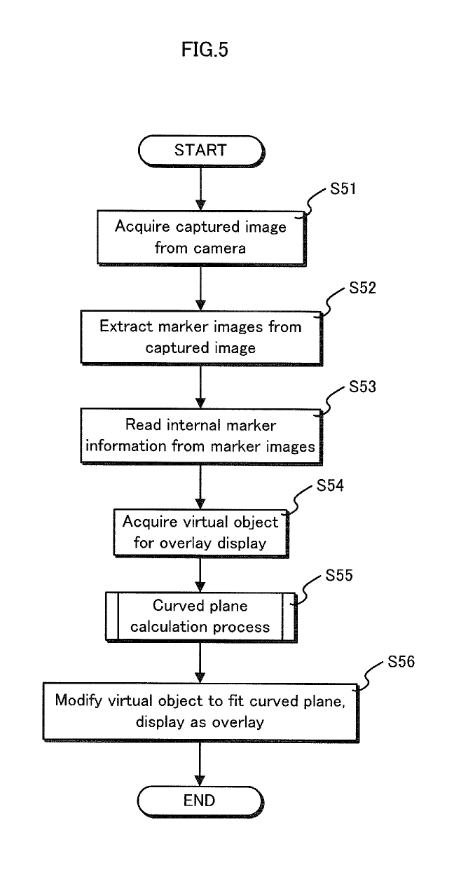

The following describes the overlay display operations of the HMD 20 with reference to FIGS. 5 though 10.

First, the acquisition unit 23 acquires an image of the two pages to which the book 10 is open, as captured by the camera 22 (S51 in FIG. 5).

Next, the marker extraction unit 24 extracts (crops out) marker images in the areas corresponding to markers 2L and 2R in the captured image, and stores coordinate information for the extracted marker images in the coordinate information storage unit 26 (S52).

The marker reading unit 28 reads the internal marker information corresponding to the areas of marker images 12L and 12R extracted by the marker extraction unit 24 and stores the internal marker information so read in the internal information storage unit 30 (S53).

Then, the virtual object specification unit 34 specifies any virtual objects among those stored in the virtual object storage unit 36 to be used for overlay display (S54).

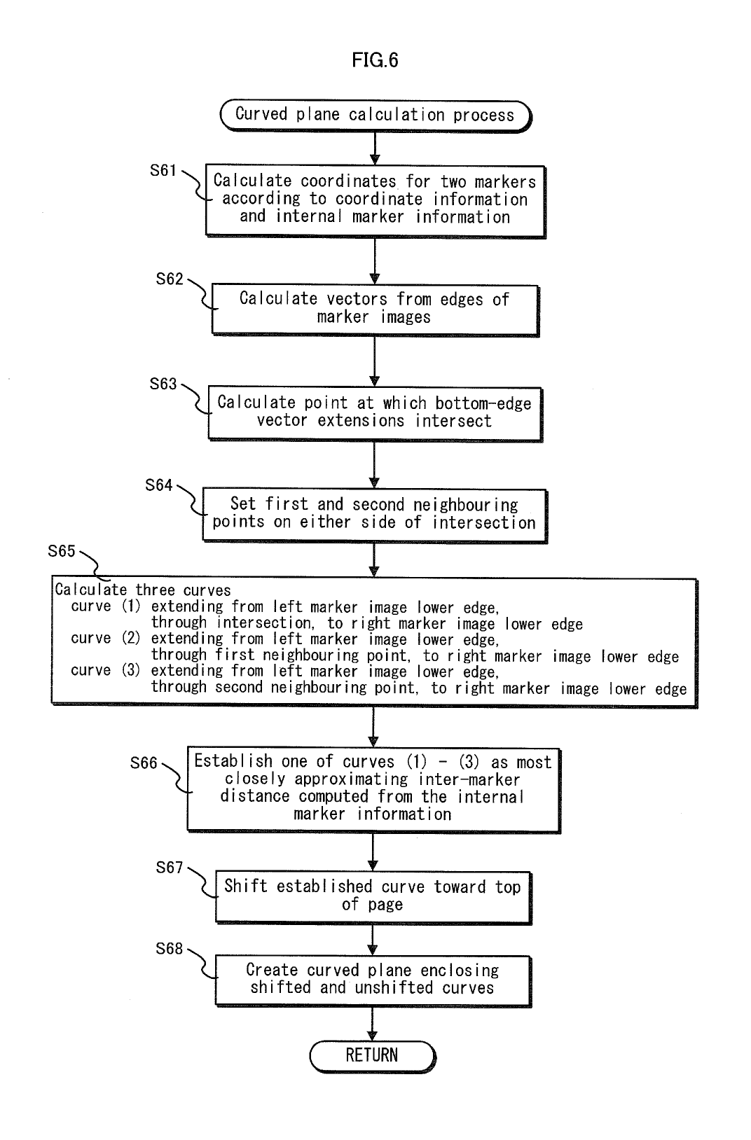

The process then proceeds with curved plane calculation, described using FIG. 6 (S55).

Before describing the process using FIG. 6, three coordinate systems handled by the present Embodiment are explained. Given that the three coordinate systems are widely used in AR technology, the following explanation is brief.
(1) Real World Coordinate System: A coordinate system used to indicate the position of an object that exists in the real world environment. In AR fields, these are often termed “world coordinates” or “global coordinates”.
(2) Camera Coordinates: Coordinate system with the camera at the origin.
(3) Screen Coordinates: Coordinate system used to project an image of the real world.

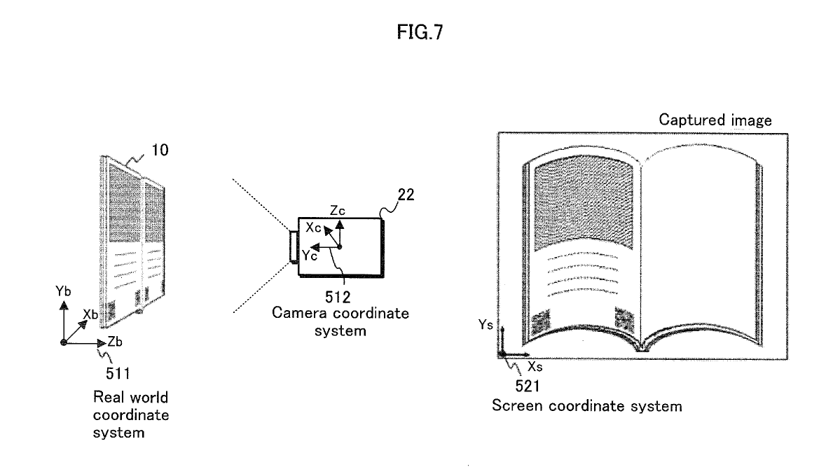

FIG. 7 illustrates uses of the real world coordinate system 511, the camera coordinate system 512, and the screen coordinate system 521.

The coordinate information extracted from the image captured by the camera 22 is expressed in terms of screen coordinate system. However, these must be converted into real world coordinate system in order to calculate the curvature of the page in the real world.

As such, in the present Embodiment, the coordinates in the screen coordinate system are converted into the camera coordinate system, then further converted into the real world coordinate system.

The former conversion, i.e., from the screen coordinate system to the camera coordinate system, is made using the method described in Non-Patent Literature 1, for example.

The later conversion, i.e., from the camera coordinate system to the real world coordinate system, is made in two steps. First the HMD 20 estimates the three-dimensional coordinates of the marker using a marker of known size (see Non-Patent Literature 1 for estimation method details). Then, a matrix calculation can be performed to accomplish the coordinate conversion, based on the estimated three-dimensional coordinates.

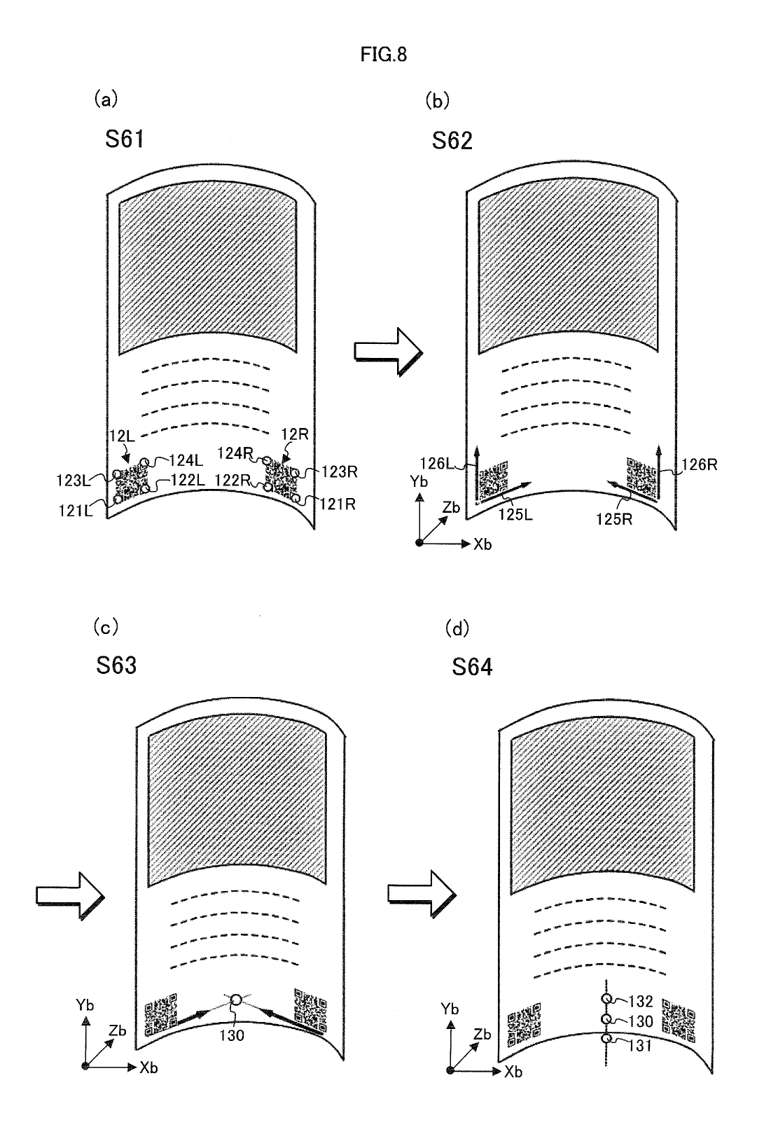

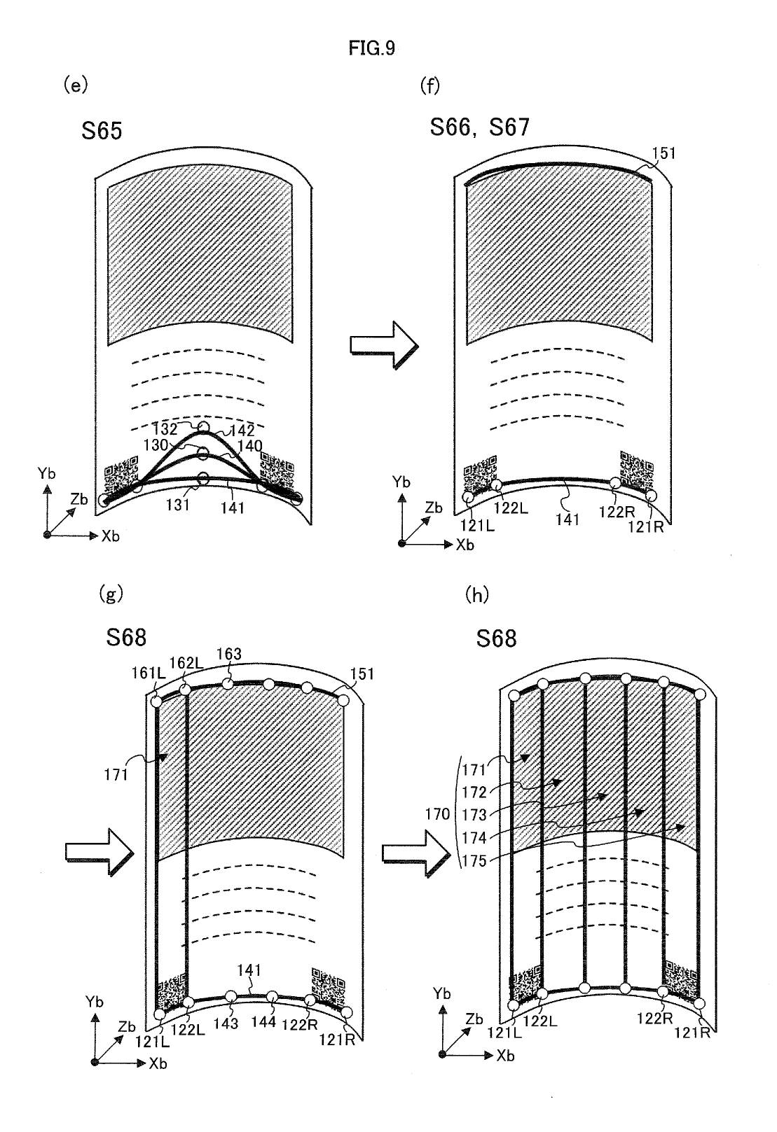

The process described by FIG. 6 is explained below using an example illustrated by FIGS. 8 and 9.

The curve calculation unit 38 calculates coordinates for the two marker images 12L, and 12R (of markers 2L and 2R) in the real world coordinate system, according to the coordinate information in the coordinate information storage unit 26 and the internal marker information in the internal information storage unit 30 (S61). Specifically, as shown in section (a) of FIG. 8, the curve calculation unit 38 calculates the coordinates of vertices 121L through 124L for marker image 12L and of vertices 121R through 124R for marker image 12R.

Next, the curve calculation unit 38 calculates vectors from the edges of the marker images 12L and 12R (S62). As shown in section (b) of FIG. 8, the curve calculation unit 38 calculates vector 125L, which runs along the lower edge of marker image 12L, and vector 126L, which runs along the left edge of marker image 12L. Similarly, the curve calculation unit 38 calculates vector 125R, which runs along the lower edge of marker image 12R, and vector 126R, which runs along the right edge of marker image 12R.

Next, the curve calculation unit 38 calculates a point at which extensions of the vector along the lower edge of marker image 12L and the vector along the lower edge of marker image 12R intersect (S63). As shown in section (c) of FIG. 8, the curve calculation unit 38 finds point 130 by extending vectors 125L and 125R until intersection. Given that the marker images 12L and 12R are actually printed on the same sheet of paper, vectors 125L and 125R are assumed to lie on a common plane (i.e., the Xb, Yb plane).

When the two vectors have a distorted positional relationship, the above method may not be applicable. In such circumstances, the (Xb, Yb) components of point 130 are taken as point A, at which the (Xb, Yb) components of the two vectors 125L and 125R intersect. Also component Zb of intersection 130 may be calculated by:
(1) finding point B at the intersection of vector 125L and a vector parallel to axis Zb, which passes through point A, and
(2) finding point C at the intersection of vector 125R and the vector parallel to axis Zb, which passes through point A,

then computing the midpoint between points B and C ((B+C)/2).

Next, the curve calculation unit 38 sets a first neighbouring point 131 and a second neighbouring point 132 on either side of point 130 (S64, FIG. 8, section (d)). The first neighbouring point 131 and the second neighbouring point 132 are found by shifting point 130 by a predetermined distance along a sum vector (oriented toward the top of the page), which is the sum of vectors 126L and 126R.

Next, the curve calculation unit 38 computes three curves, namely:
(1) curve 140, which extends from the lower edge of the left-hand marker image 12L through point 130 to the lower edge of the right-hand marker image 12R,
(2) curve 141, which extends from the lower edge of the left-hand marker image 12L through the first neighbouring point 131 to the lower edge of the right-hand marker image 12R, and
(3) curve 142, which extends from the lower edge of the left-hand marker image 12L through the second neighbouring point 132 to the lower edge of the right-hand marker image 12R (S65, FIG. 9, section (e)).

Calculating these curves enables calculation of a spline joining five points, namely the two vertices 121L and 121R on the lower left, the center point 130, and the two vertices 122R and 121R on the lower right, which is then used to compute curve 140. Similarly, curves 141 and 142 are computed by replacing the center point with the appropriate one of the first neighbouring point 131 and the second neighbouring point 132.

Once the three curves have been calculated, the curve calculation unit 38 establishes one of the curves as most closely approximating the inter-marker distance computed from the internal marker information (S66).

As described with reference to FIG. 3, the curve calculation unit 38 computes the inter-marker distance from the coordinates of the two marker images 12L and 12R, respectively (50, 750) and (450, 750), as being 400. The curve calculation unit 38 then finds the curve most similar to this distance of 400 among the three curves 140 through 142 (curve 141 in the example of FIG. 9, section (f)).

Subsequently, the curved plane creation unit 40 calculates a curve 151 by shifting the established curve 141 away from point 130 along the sum vector (oriented toward the top of the page), which is the sum of vectors 126L and 126R (S67, FIG. 9, section (f)).

Next, the curved plane creation unit 40 creates a curved plane that includes the unshifted curve 141 and the shifted curve 151 (S68).

Specifically, as shown in section (g) of FIG. 9, the curved plane creation unit 40 creates small curved plane 171 that includes four points, namely points 121L and 122L on curve 141, and points 161L and 162L, which correspond to points 121L and 122L once shifted toward the top.

The curved plane creation unit 40 then similarly creates small curved plane 172, which includes points 122L, 143, 162L, and 163, and further proceeds to create small curved planes 173 through 175. The curved plane creation unit 40 then connects the small curved planes 171 through 175 so created into curved plane 170 (FIG. 9, section (h)). Curved plane 170 represents the degree of curvature of the left page of the book 10, as opened.

While the example of FIG. 9 shows six points on curve 141, no limitation is intended. Any number of points may be used. Setting more points allows a more precise curved plane to be created, but increases the processing load.

When the curved plane calculation process (S55 in FIG. 5) is complete, the virtual object is distorted to fit the curved plane and displayed as an overlay on the display 46 (S56).

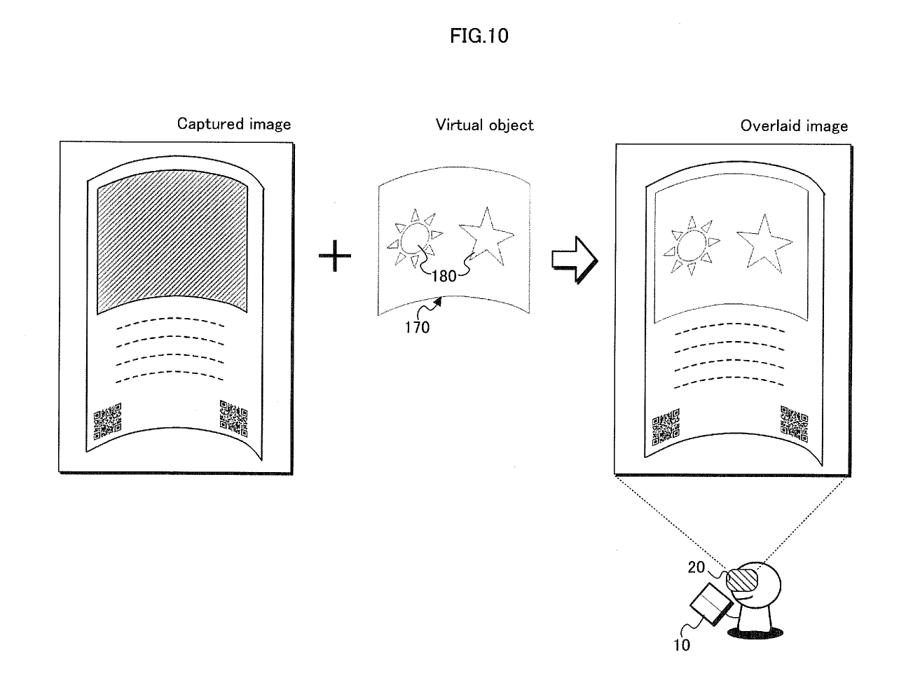

FIG. 10 illustrates an example of overlay display.

FIG. 10 indicates that the HMD 20 displays an image (overlay image) made up of (i) one image (the virtual image) of the virtual object 180 distorted to match the curved plane 170, overlaid on (ii) another image (the captured image).

The virtual object 180 is distorted by texture mapping the virtual object 180 onto the curved plane 170.

The virtual object 180, indicated as a set of a sun and star displayed by the HMD 20, are distorted to match the curved plane 170. Thus, the user sees the sun and star as if actually drawn on the page to which the user has opened the book 10.

This also prevents the image from being perceived as unnatural, such as by preventing the virtual object 180 from appearing shifted lengthwise with respect to the page, and preventing the virtual object 180 from appearing shifted depthwise so as to float above or be sunk into the page.

As described above, according to the present Embodiment, two markers printed on the page are used to calculate a curved plane corresponding to the curvature of the page. The curved plane calculation can be performed without requiring a large number of markers, and the processing is relatively light. As such, the present Embodiment is well-suited to HMD applications.

### Embodiment 2

In Embodiment 2, a present location marker is displayed as a virtual object overlaid on an image of a book in which a map is drawn. The basic configuration is similar to that of Embodiment 1. Thus, the following explanation centers on the points of difference.

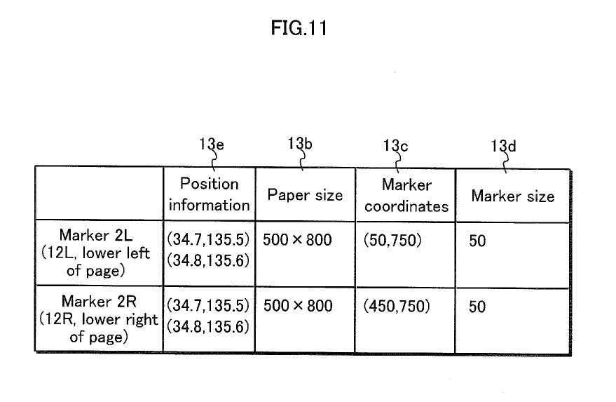

FIG. 11 illustrates an example of internal marker information embedded into markers 2L and 2R.

The internal marker information is similar to that described using FIG. 3, differing in the addition of position information 13e. This position information 13e indicates a latitude and longitude range covered by the map on the page where the markers 2L and 2R are printed.

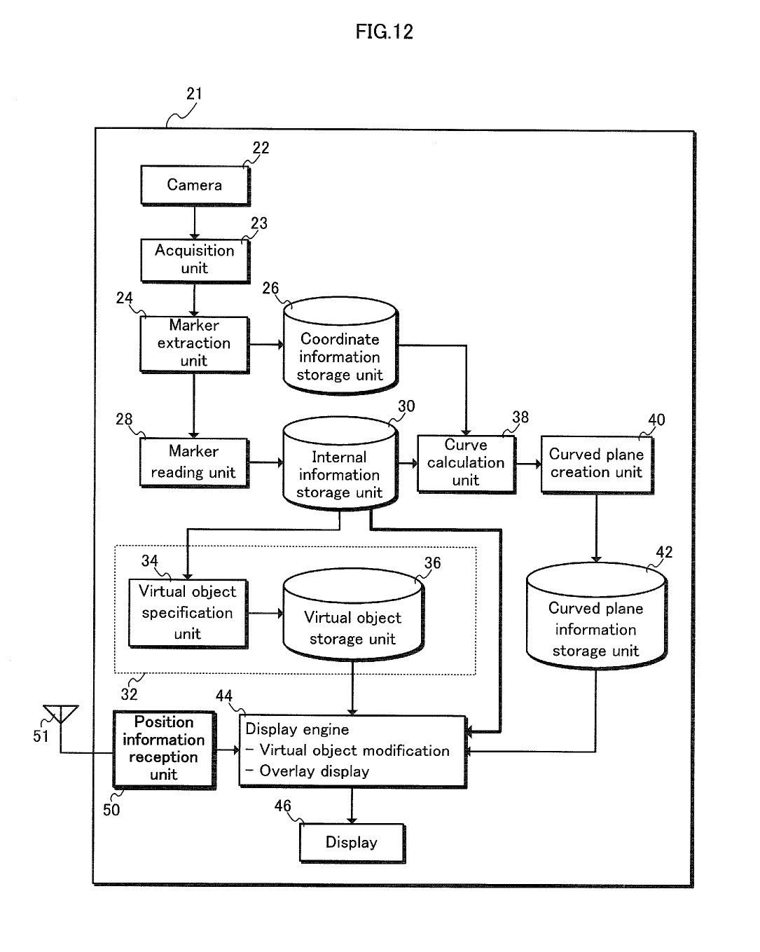

FIG. 12 is a functional block diagram of the HMD 21. The functional block diagram uses the same reference signs as FIG. 4 wherever applicable. Explanations thereof are thus omitted.

A position information reception unit 50 receives position information from an ordinary GPS (Global Positioning System) unit via a GPS antenna 51.

The display engine 44 distorts a current position marker stored in the virtual object storage unit 36 to conform to a curved plane stored in the curved plane information storage unit 42.

The internal information storage unit 30 also establishes the coordinate system of the aforementioned curved plane according to the position information in the internal marker information stored in the internal information storage unit 30, and makes an overlay display of the current position mark indicated by the position information reception unit 50.

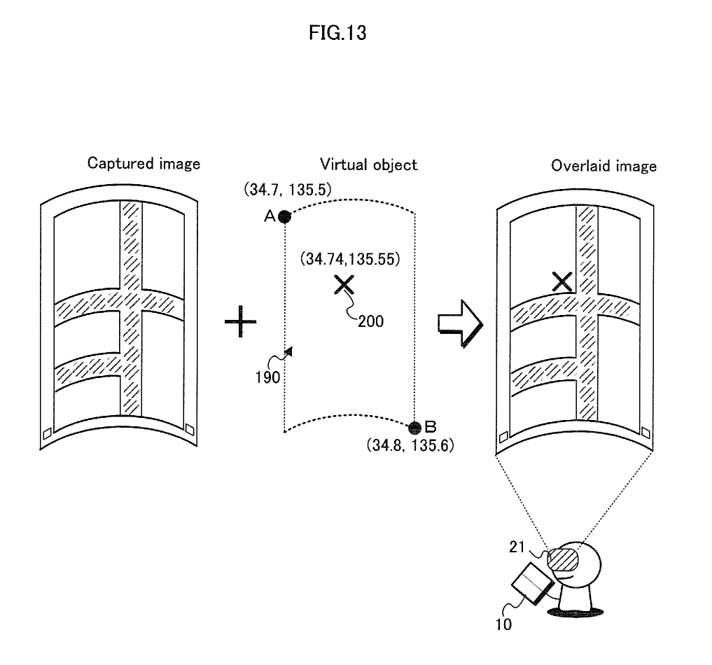

FIG. 13 illustrates an example of overlay display.

As indicated by the virtual image in FIG. 13, the display engine 44 establishes the coordinates according to the position information 13e (see FIG. 11) in the internal marker information such that (34.7, 135.5) is at point A in the upper-left corner of the page and that (34.8, 135.6) is at point B in the lower-right corner of the page.

The display engine 44 then distorts the current position mark 200 to conform to the curved plane 190 and arranges the distorted mark at the position (34.74, 135.55) indicated by the position information reception unit 50.

The overlay display illustrated in FIG. 13 indicates that the current position mark is displayed on the map printed on the page. The user wearing the HMD 21 is thus able to confirm their current position.

According to Embodiment 2, a user viewing a paper book on which a map is printed can be made more convenient through the display of overlay information indicating the current position. Also, this overlay display can be used without recourse to network communications.

Also, the mark 200 is distorted to conform to the curved plane 190 and displayed as an overlay thereon. As such, the mark is prevented from appearing shifted lengthwise with respect to the page. Specifically, when the map includes narrow passages and the like, preventing such shifts enables the current position to be more accurately displayed.

### Embodiment 3

The overlay display described above must be performed in real time, yet the processing power of an HMD often lags behind that of a typical PC.

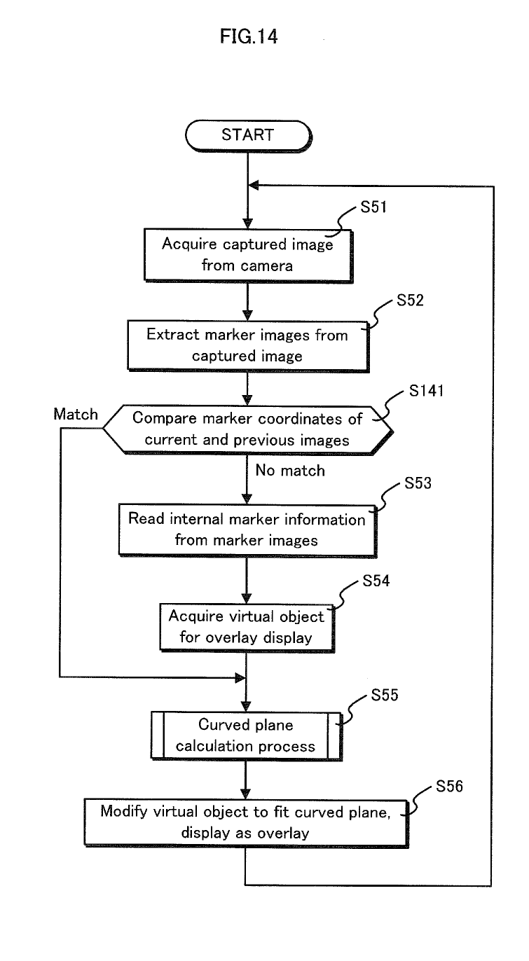

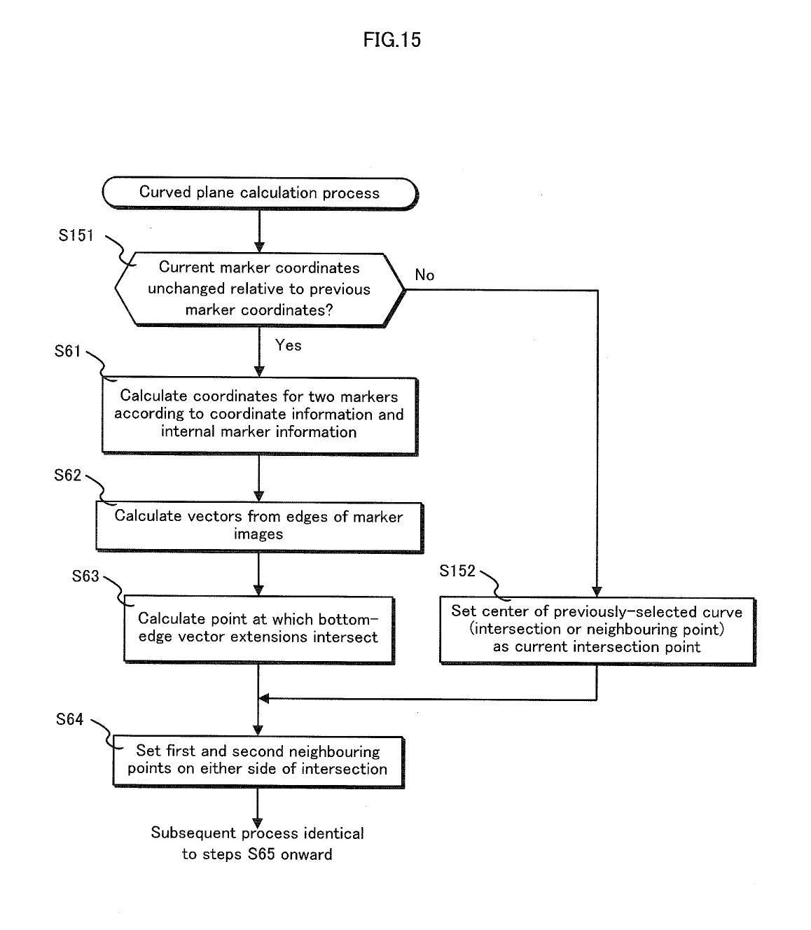

Embodiment 3 lightens the processing load for internal marker information reading (see FIG. 14) and fir curved plane calculation (see FIG. 15).

As shown in FIG. 14, after the marker image is extracted from the captured image (S52), the marker extraction unit 24 compares the marker coordinates of the previous marker image to those of the current marker image. If there is a match (Match in S141), the internal marker information reading process (S53, S54) is skipped and the previously read internal marker information is re-used.

Real time overlay display involves the camera 22 capturing images at, for example, 60 fps, yet the marker coordinates hardly change between marker images. This approach to processing in this way enables reduction of the internal marker information reading processing load.

Also, as shown in FIG. 15, when the marker coordinates in the current image undergoing the curved plane calculation process is unchanged relative to the previous image (No in S151), the curve calculation unit 38 sets the central point (a point of intersection or neighbouring point) from the previous ultimately-established curve as the point of intersection for the current process (S152). As such, steps S61 through S63 can be skipped, thus lightening the load.

(Supplement 1)

While the Embodiments are described above in terms of examples, the present invention is not limited as such. Numerous variations are also applicable to the realization of the same aim or of related aims, such as the following.

### (1) Neighbouring Point Determination

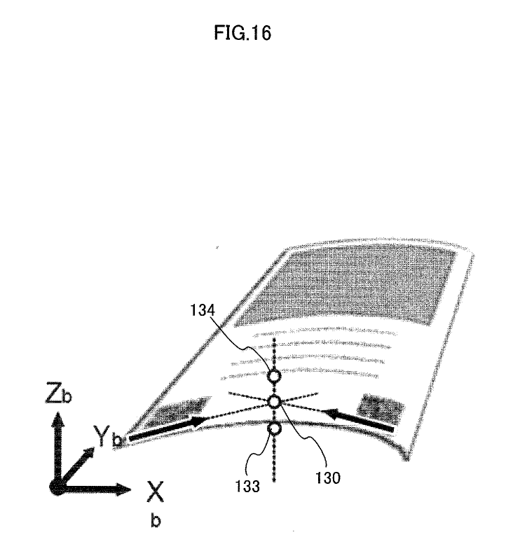

In the Embodiments, as shown in section (d) of FIG. 8, neighbouring points 131 and 132 are created by shifting point 130 along a vector oriented toward the top of the page. However, no limitation is intended. As shown in FIG. 16, neighbouring points 133 and 134 may also be set along a straight line along the Zb axis (corresponding to the depth axis of the page).

Also, although FIG. 8 shows two neighbouring points created, more points may be created when there is processing capacity to spare.

### (2) Curve Creation

In the Embodiments, as shown in section (e) of FIG. 9, a spline curve is created. However, curve creation is not limited to this method.

Bezier curves, Bezier spline curves (e.g., a spline curve obtained by generating a Bezier curve for each segment, and then connecting the Bezier curves so generated) and the like may also be employed.

Also, in order to reduce the time needed to calculate the distance between curves, a broken line drawn by connecting the five points used in the spline calculation (e.g., points 121L, 122L, 130, 122R, and 121R) may instead be used.

### (3) Page Quality

In the Embodiments, the book 10 is described as having pages made of paper. However, no limitation is intended. Any flexible display material capable of curving may be used.

### (4) Virtual Object

In the Embodiments, the virtual object to be displayed by the HMD 20 is stored in the virtual object storage unit 36. However, the virtual object need not be stored and may instead be acquired from an external source.

For example, the internal marker information for a marker may include a URL (Uniform Resource Locator) as part of the information identifying the virtual object. The HMD 20 may then acquire the virtual object from the locator indicated by the URL via a network.

Furthermore, the virtual object is not limited to a flat (i.e., two-dimensional) image, but may also be a stereoscopic (i.e., three-dimensional) image.

For example, when a moving character is being displayed as a stereoscopic image on a curved plane, the curved plane created by the curved plane creation unit 40 may be used for collision determination, and a friction coefficient may be set therefor.

### (5) Camera

In the Embodiments, the HMD 20 includes a camera 22. However, the camera is not strictly necessary, and an HMD with no camera may also be used. In such circumstances, the HMD may, for example, be connected to an external camera through a communication cable and acquire images captured by the camera through the acquisition unit.

### (6) Curved Plane Creation

In the Embodiments, the curves, once calculated, are used to create a curved plane. However, no limitation is intended. The curved plane may also be calculated using a method that does not involve curves.

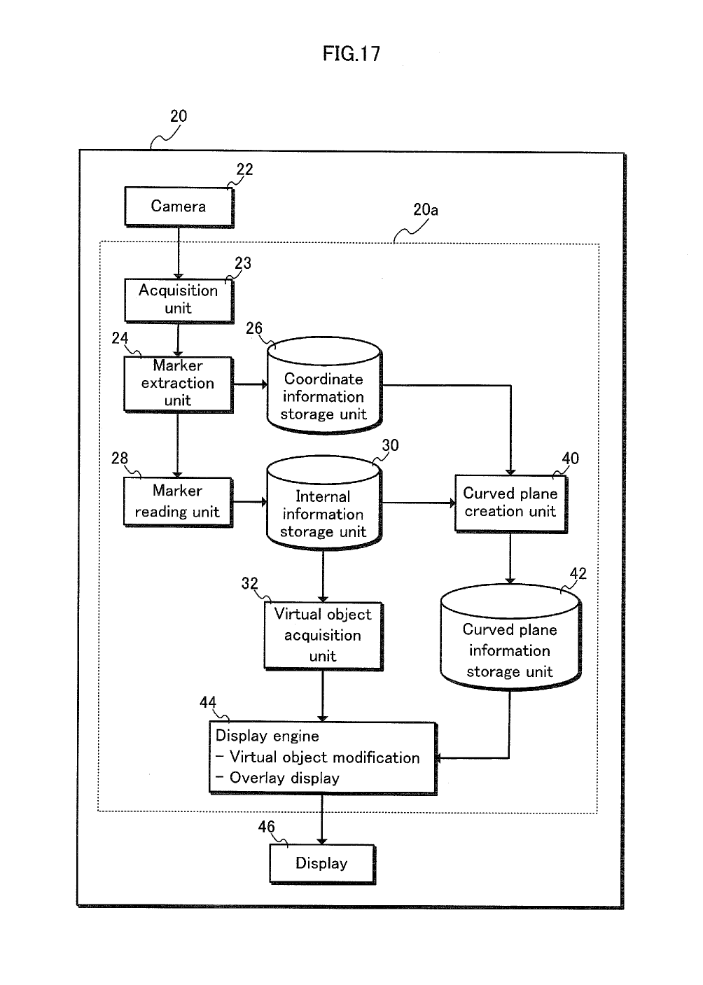

FIG. 17 illustrates the key components 20a of the HMD 20, in consideration of variations 5 and 6.

### (7) Program

A control program made up of program code for causing the processors of an information processing device, or of circuits connected to the processor, to execute the operations and so on discussed in the above-described Embodiments may be recorded on a recording medium or circulated and distributed through various communication channels.

The recording medium may be an IC card, a hard disk, an optical disc, a floppy disc, ROM, or any other non-transitory recording medium.

The control program so circulated and distributed is supplied on memory readable by the processor. The various functions described in the Embodiments are realized through the processor executing the control program.

### (8) LSI

The functional blocks indicated in the drawings may be realized as an LSI integrated circuit. Each functional block may be realized as a single chip, or a single chip may be used realize a subset of or the entirety of the functions. Although LSI is named above, any of IC, system LSI, super LSI, and ultra LSI may be used, the name depending on the degree of integration.

Also, the integration method is not limited to LSI. A dedicated circuit or a general purpose processor may also be used. After LSI manufacture, an FPGA (Field Programmable Gate Array) or a reconfigurable processor may also be employed. Furthermore, advances and developments in semiconductor technology may lead to new technology coming to replace LSIs. Such future technology may, of course, be applied to the integration of the functional blocks.

(Supplement 2)

The Embodiments include the following aspects.
(1) A display processing device pertaining to one aspect for displaying a virtual object upon overlay on a captured image of a real world environment comprises: an acquisition unit acquiring a captured image of a page in a book; an extraction unit extracting one or more marker images from the captured image so acquired; a creation unit creating a curved plane according to the marker images, the curved plane representing a degree of curvature for the page; and a display processing unit modifying a virtual object according to the curved plane and overlaying the virtual object so modified on the captured image for display.
(2) Also, the extraction unit may extract a first marker image and a second marker image, and the creation unit may calculate a curve representing a degree of curvature for the page according to the first marker image and the second marker image, and create the curved plane according to the curve.
(3) Further, with respect to a length axis of the page, a printed marker corresponding to the first marker image may be on the left while another printed marker corresponding to the second marker image is on the right, the printed markers each having an edge extending along a lateral axis of the page, the curve calculated by the creation unit may pass through the edge of the first marker image and the edge of the second marker image, and the creation unit may create the curved plane by translating the curve along the length axis of the page in the captured image.
(4) Alternatively, a reading unit may read information indicating coordinates of the printed markers on the page respectively corresponding to the first marker image and the second marker image; and a calculation unit may calculate a distance between the coordinates from the information so read, wherein the creation unit calculates the curve according to the distance so calculated.
(5) The creation unit may: compute an intersection point between a line extending from the edge of the first marker image and a line extending from the edge of the second marker image; create (a) a single curve passing from the edge of the first marker image through the intersection point to the edge of the second marker image, and (b) one or more curves each passing from the edge of the first marker image through a neighbouring point near the intersection point to the edge of the second marker image; and establish an ultimate curve having a length most similar to the calculated distance, among all created curves.
(6) The neighbouring point may be found by shifting the intersection point along the length axis or a depth axis of the page in the captured image.
(7) The reading unit may read information from at least one of the first marker image and the second marker image, the information identifying the virtual object, and the display processing unit may take the virtual object identified by the reading unit as a subject of overlay for display.
(8) Furthermore, a map may be printed on the page, the reading unit may read coordinate information indicating a range of coordinates covered by the map on the page from at least one of the first marker image and the second marker image, the display processing device may further comprise a reception unit receiving position information indicating a current position, and the display processing unit may modify a current position marker serving as the virtual object according to the curved plane and overlays the current position marker as modified on the captured image for display at a position on the page in the captured image determined according to the position information indicated by the coordinate information.
(9) Also, the printed markers corresponding to the first marker image and the second marker image may be rectangular, each having an edge extending along the lateral axis the page and an edge extending along the length axis of the page, and the creation unit may perform the translation along the length axis with reference to the edge of the first marker image or of the second marker image that extends along the length axis of the page.
(10) In addition, the acquisition unit may regularly repeat the captured image acquisition, and before extraction, the extraction unit may compare a previously acquired image to the captured image presently acquired for identity and, when identity is confirmed, output the first marker image and second marker image extracted from the previously acquired image as present results, without performing extraction.
(11) The first marker image and the second marker image may be two-dimensional codes.
(12) The captured image may be an image of the page to which the book is open.
(13) A display processing method pertaining to another aspect for displaying a virtual object upon overlay on an image of a real world environment, comprises: an acquisition step of acquiring a captured image of a page in a book; an extraction step of extracting one or more marker images from the captured image so acquired; a creation step of creating a curved plane according to the marker images, the curved plane representing a degree of curvature for the page; and a display processing step of modifying a virtual object according to the curved plane and overlaying the virtual object so modified on the captured image for display.

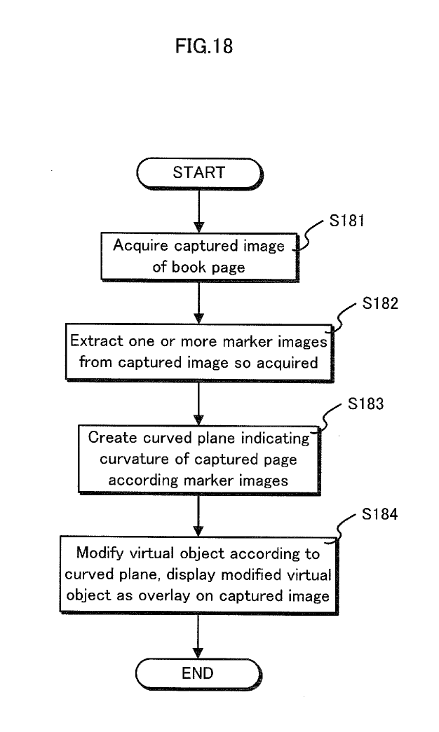

The acquisition step, extraction step, creation step, and display processing step are given as steps S181 through S184 of FIG. 18.
(14) A program pertaining to a further aspect for causing a display processing device to execute a process of displaying a virtual object upon overlay on an image of a real world environment, the process comprising: an acquisition step of acquiring a captured image of a page in a book; an extraction step of extracting one or more marker images from the captured image so acquired; a creation step of creating a curved plane according to the marker images, the curved plane representing a degree of curvature for the page; and a display processing step of modifying a virtual object according to the curved plane and overlaying the virtual object so modified on the captured image for display.

### INDUSTRIAL APPLICABILITY

The display processing device pertaining to the present invention is applicable to the provision of augmented reality realized so as to minimize discomfort for the user.

### REFERENCE SIGNS LIST

1 Reading system
2L, 2R, 4L, 4R Marker (Printed portion corresponding to marker image)
10 Book
12L, 12R, 14L, 14R Marker image
20, 21 HMD (Example of display processing device)
20a Key HMD components
22 Camera
23 Acquisition unit
24 Marker extraction unit
26 Coordinate information storage unit
28 Marker reading unit
30 Internal information storage unit
32 Virtual object acquisition unit
34 Virtual object specification unit
36 Virtual object storage unit
38 Curve calculation unit
40 Curved plane creation unit
42 Curved plane information storage unit
44 Display engine (Example of display processing unit)
46 Display
50 Position information reception unit
51 GPS antenna
140, 141, 142 Curve
170 Curved plane
180 Virtual object
190 Curved plane
200 Mark (Example of virtual object)

1. A display processing device for displaying a virtual object upon overlay on a captured image of a real world environment, comprising:
an acquisition unit acquiring a captured image of a page in a book;
an extraction unit extracting one or more marker images from the captured image so acquired;
a creation unit creating a curved plane according to the marker images, the curved plane representing a degree of curvature for the page; and
a display processing unit modifying a virtual object according to the curved plane and overlaying the virtual object so modified on the captured image for display.

2. The display processing device of claim 1, wherein
the extraction unit extracts a first marker image and a second marker image, and
the creation unit calculates a curve representing a degree of curvature for the page according to the first marker image and the second marker image, and creates the curved plane according to the curve.

3. The display processing device of claim 2, wherein
with respect to a length axis of the page, a printed marker corresponding to the first marker image is on the left and another printed marker corresponding to the second marker image is on the right, the printed markers each having an edge extending along a lateral axis of the page,
the curve calculated by the creation unit passes through the edge of the first marker image and the edge of the second marker image, and
the creation unit creates the curved plane by translating the curve along the length axis of the page in the captured image.

4. The display processing device of claim 3, further comprising:
a reading unit reading information indicating coordinates of the printed markers on the page respectively corresponding to the first marker image and the second marker image; and
a calculation unit calculating a distance between the coordinates from the information so read, wherein
the creation unit calculates the curve according to the distance so calculated.

5. The display processing device of claim 4, wherein the creation unit:
computes an intersection point between a line extending from the edge of the first marker image and a line extending from the edge of the second marker image;
creates (a) a single curve passing from the edge of the first marker image through the intersection point to the edge of the second marker image, and (b) one or more curves each passing from the edge of the first marker image through a neighbouring point near the intersection point to the edge of the second marker image; and
establishes an ultimate curve having a length most similar to the calculated distance, among all created curves.

6. The display processing device of claim 5, wherein
the neighbouring point is found by shifting the intersection point along the length axis or a depth axis of the page in the captured image.

7. The display processing device of claim 4, wherein
the reading unit reads information from at least one of the first marker image and the second marker image, the information identifying the virtual object, and
the display processing unit takes the virtual object identified by the reading unit as a subject of overlay for display.

8. The display processing device of claim 4, wherein
a map is printed on the page,
the reading unit reads coordinate information indicating a range of coordinates covered by the map on the page from at least one of the first marker image and the second marker image,
the display processing device further comprises a reception unit receiving position information indicating a current position, and
the display processing unit modifies a current position marker serving as the virtual object according to the curved plane and overlays the current position marker as modified on the captured image for display at a position on the page in the captured image determined according to the position information indicated by the coordinate information.

9. The display processing device of claim 3, wherein
the printed markers corresponding to the first marker image and the second marker image are rectangular, each having an edge extending along the lateral axis the page and an edge extending along the length axis of the page, and
the creation unit performs the translation along the length axis with reference to the edge of the first marker image or of the second marker image that extends along the length axis of the page.

10. The display processing device of claim 2, wherein,
the acquisition unit regularly repeats the captured image acquisition, and
before extraction, the extraction unit compares a previously acquired image to the captured image presently acquired for identity and, when identity is confirmed, outputs the first marker image and second marker image extracted from the previously acquired image as present results, without performing extraction.

11. The display processing device of claim 2, wherein
the first marker image and the second marker image are two-dimensional codes.

12. The display processing device of claim 2, wherein
the captured image is an image of the page to which the book is open.

13. A display processing method for displaying a virtual object upon overlay on an image of a real world environment, comprising:
an acquisition step of acquiring a captured image of a page in a book;
an extraction step of extracting one or more marker images from the captured image so acquired;
a creation step of creating a curved plane according to the marker images, the curved plane representing a degree of curvature for the page; and
a display processing step of modifying a virtual object according to the curved plane and overlaying the virtual object so modified on the captured image for display.

14. A program for causing a display processing device to execute a process of displaying a virtual object upon overlay on an image of a real world environment, the process comprising:
an acquisition step of acquiring a captured image of a page in a book;
an extraction step of extracting one or more marker images from the captured image so acquired;
a creation step of creating a curved plane according to the marker images, the curved plane representing a degree of curvature for the page; and
a display processing step of modifying a virtual object according to the curved plane and overlaying the virtual object so modified on the captured image for display.
